(19) United States
(12) Patent Application Publication
(10) Pub. No.: US 2008/0163281 A1
(43) Pub. Date: Jul. 3, 2008

(54) Read-Side Anti-Theft Discs

(75) Inventor: Richard H. Selinfreund, Terre Haute, IN (US)

Correspondence Address: KELLEY DRYE & WARREN LLP, 400 ALTLANTIC STREET , 13TH FLOOR, STAMFORD, CT, 06901, US

(73) Assignee: Verification Technologies, Inc., Essex, CT (US)

(21) Appl. No.: 11/964,545

(22) Filed: Dec. 26, 2007

Related U.S. Application Data
(60) Provisional application No. 60/882,088, filed on Dec. 27, 2006.

(51) Int. Cl. G11B 7/24

(52) U.S. Cl. 720/718

(57) ABSTRACT

An optical medium designed to reduce unauthorized read and theft, dye systems useful in making such discs, and methods of select application of the dye systems to recording medium.

### CROSS-REFERENCE TO RELATED APPLICATIONS

This utility patent application claims priority to U.S. Provisional Application No. 60/882,088. All references cited in this specification, and their references, are incorporated by reference herein where appropriate for teachings of additional or alternative details, features, and/or technical background.

### BACKGROUND OF THE INVENTION

1. Field of the Invention

The present invention generally relates to an optical medium designed to reduce unauthorized read and theft, dye systems useful in preventing unauthorized read/theft, and methods of select application of the dye systems to recording medium to effectuate protection against unauthorized read/theft.

2. Description of the Related Art

Spin coating dyes on optical media is well known in the field of write once read many times discs (WORM). An entire manufacturing expertise had been developed to engineer the equipment, develop the chemistry and manufacture laser based recording media. Previously, a method to manufacture an anti-theft optical disc using dye systems and spin coat methods has been developed (see, e.g., WO 2006/116493 A2). These discs are coated over the entire surface with a material that stops the disc from playing.

Application of a dye substance over an entire disc may be relatively expensive. Further, as many dye systems are polar in character there may be difficulty in placing such dyes in a non-polar hard coat material, such as a non-polar UV quenching hardcoat. Dye coatings over an entire disc may also lead to playability problems, a problem that may be seen in particular with respect to DVD-9 optical discs used for DVD movies. Application of the dye to entire recording medium, such as a disc, may also slow down the production of disc both in the application of the material and in the check necessary to determine if the material is appropriately applied across the medium.

There is a need therefore, for an improved method of providing anti-theft recording media that does not require the application of dye systems to the entire medium.

### DEFINITIONS

“Digital Recording Medium”: a medium of any geometric shape (not necessarily circular) that is capable of storing information in digital form thereon. Digital Recording Medium includes, without limitation, CD, DVDs, HD-DVDs, electromagnetic tape and disks, flash drives and Optical Medium. Information stored on the medium may include, without limitation, software programs, software data, sensory files, audio files and video files.

“Light-Activated State-Change Material”: a State-Change Material that alters a measurable parameter upon application of a wavelength, or subwavelength, of light or application of photonic energy to the material.

“Optical Medium”: a medium of any geometric shape (not necessarily circular) that is capable of storing indicia or content that may be read by an optical reader.

“Optical Reader”: a Reader (as defined below) for the reading of optical medium.

“Permanent State-Change Material”: a State-Change Material that once activated to change a measurable parameter upon application of energy to the material, stays in such state permanently or for a prolonged period of time.

“Reader”: any device capable of detecting indicia that has been recorded on an optical medium. By the term “reader” it is meant to include, without limitation, a player. Examples are CD and DVD readers.

“Recording Layers”: one or more layers of an optical medium where indicia or content is recorded for reading, playing or uploading to a computer. Such content may include, without limitation, software programs, software data, audio files and video files.

“State-Change Material”: a material capable of altering a measurable property of the material upon activation of the material by application of energy to the material. Such term does not include holographs. “State-Change Material” is meant to include, without limitation, materials that change in optical state (e.g., opacity, reflection and/or color) (an “Optical State-Change Material”) upon application of energy to the materials, materials that change in electromagnetic state (e.g., electroconductive state) upon application of energy to the materials, and materials that change in physical state (e.g. crystalline to non-crystalline structure, materials that shrink upon application of heat) upon application of energy to the material.

“Temporary State-Change Material”: a State-Change Material that, once activated to change a measurable property of the material upon application of energy to the material, stays in such state for a period of time less than a year.

“Three-dimensional Optical Recording Medium”: an optical medium permitting storage of indicia or content in more than one plane or recording layer on an optical medium.

“Transportable Recording Medium”: a relatively small medium capable of being transported by hand from one location to another. It includes, without limitation, Transportable Digital Recording Medium such as an optical disc, a floppy disk, a flash drive.

“Transient State-Change Material”: a State-Change material that, once activated to change a measurable property of the material, spontaneously in a short period of time (minutes or less), loses such change in the measurable property. It includes, without limitation, materials that move from a first state to a second state upon application of energy, and back to the first state without application of energy.

For the purpose of the rest of the disclosure, it is understood that the terms as defined above are intended whether such terms are in all initial cap, or not.

### SUMMARY OF THE INVENTION

It has been found that anti-theft/anti-unauthorized read recording medium, wherein a dye system is used to block read until it is activated with an appropriate energy source (such as a wavelength of light) such as, for example, described in WO 2006/116493 A2 (or the dye system disclosed below), may be produced by application of the dye system only over the lead-in area of optical medium. As would be understood by one of ordinary skill in the art, such lead-in area includes, without limitation, about 42 mm to about 43.5 mm on a DVD, about 23.1 to about 25 mm on a CD, and about 22 to about 24 mm on a BD.

By application of the dye system to the lead-in area of the optical disc, there may be significant saving on the cost of coating material needed to produce an anti-theft disc (for example, a 10-fold decrease), there may be increased production speed in the production of discs (for example, from minutes to seconds), there may be less of a tendency for the dye system for interfere with the digital content read (i.e., reduce the probability that imperfection in the dye coating material cause playability problems in the customers content), there may be faster quality check of each disc owning to less of the disc needing to be checked, and there may be less chance for the optical coating to interfere with content fidelity, for example, L layer digital content on DVD-9.

There is disclosed in embodiment herein as further discussed below, a theft-protected digital recording medium comprising a disc having an optical state change material applied only in the lead-in area of the optical disc. Such theft-protected disc may be an optical medium. The theft-protected disc is not readable by a digital reader or an optical reader until the optical state change material is activated to new state.

The optical state change material may be a light-activated state-change material. The optical state change material may be selected from a group consisting of: a permanent state-change material, a temporary state-change material, and a transient state-change material. The disc may be a transportable recording medium. In an embodiment, the optical state change material is located over digital datum indicia in the lead-in area of the optical disc. A thin protective coating may be applied prior to application of the state change material to protect the optical disc substrate from attack by solvents.

In embodiments, the theft-protected optical disc is produced by imprinting by ink jet printing an optical state change material only in the lead-in area of the optical disc. The ink jet imprinting may be, for example, by a piezo printer, a drop on demand ink jet printer or a continuous ink jet ink jet printer and may be applied simultaneously with label side printing. The imprinting may be, for example, by visible text. Optionally, the visible text may indicate to a customer that the disc must be activated to be playable. The imprinting may be in special patterns, such as a diamond-like pattern and a serrated-edge pattern.

### BRIEF DESCRIPTIONS OF DRAWINGS

FIG. 1A illustrates a polycarbonate disc coated with ethyl acetate material used to dissolve a dye system of the present invention;

FIG. 1B illustrates a polycarbonate disc of the type shown in FIG. 1A in which the disc is further coated with a UV cure protective coating (alter application of the same ethyl acetate composition coating of FIG. 1A);

FIG. 2A illustrates a diamond-like printing indicia that may be applied to a recording medium of the present invention; and

FIG. 2B illustrates a serrated-edge printing indicia that may be applied to a recording medium of the present invention.

### DETAILED DESCRIPTION OF THE INVENTION

The present invention provides for optical medium designed to reduce unauthorized read and theft, dye systems useful in preventing unauthorized read/theft, and methods of select application of the dye systems to recording medium to effectuate protect against unauthorized read/theft.

In one embodiment, there is provided a protective coat placed over the polycarbonate disc before the organic dye layer is coated. In such embodiment, the coating chemistry contains a material that only dissolves in organic solvent. Organic chemicals are well known to possibly damage polycarbonate used to manufacture optical media. A high speed low cost chemical barrier that would allow use organic solvents in the coating of the media and at the same time protect the polycarbonate disc material could be advantageous. In such embodiment, there is provided thin (less than 3 microns); high speed (less than 2 second-ultra-violet cure cycle) and low cost (less than 0.2 cents per disc) protective coat. In such embodiment, the protective coating added below the dye layer system-rules out the need for low ultraviolet transmission of the coating material. The coating materials can be modified to allow binding of the dye system printing vehicles. Dye systems, such as disclosed in other of Applicant's issued and pending patent applications related to anti-theft recording medium, may be employed.

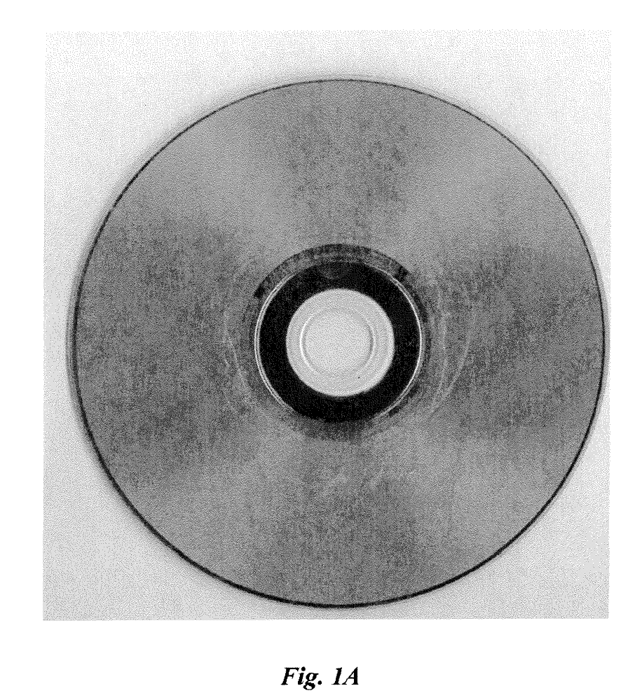

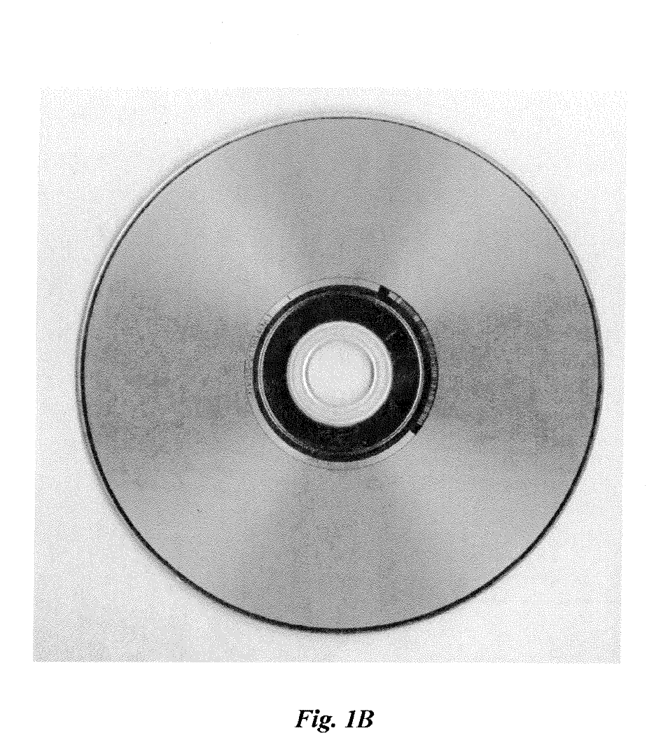

FIG. 1A illustrates a polycarbonate disc coated with ethyl acetate material used to dissolve the dye system. Esters like butyl acetate and ethyl acetate induce what is termed a class 4 attack on the polycarbonate (Reference Dow Product Information Supplemental Form No. 770-000304-106). The attack on the poly carbonate is graded from 1-4 with 1 representing no observable effect. It induces, major etching swelling and loss of gloss which would interfere with the read portion of the lead-in region on the disc. FIG. 1B, is the same type of polycarbonate disc coated with UV cure protective coating after the very same ethyl acetate exposure. These disc with the protective coating were tested by soaking in ethyl acetate for 24 hrs. No effect was observed on playability as set forth in table 1 below:

TABLE I

| Test | Parameter Measured | Value |
|---|---|---|
| 1. | Eccent. Ave. | 11.00 |
| 2. | DPD Ave. | 0.6681 |
| 3. | TSC Ave. | 0.2166 |
| 4. | JTAve Ave. | 5.1416 |
| 5. | Reflave Ave. | 0.2395 |

The UV cure protective coating may be found to be advantageous in offering protection against solvents such as are set forth below in Table II:

TABLE II

| | Evaporation Rate | | | |
|---|---|---|---|---|
| Solvent | nBuAc = 1 | Dispersion* | Polar* | Hydrogen* |
| Butyl CARBITOL ™ Solvent | 0.004 | 16.0 | 7.0 | 10.6 |
| Butyl CELLOSOLVE ™ Solvent | 0.079 | 16.0 | 7.6 | 12.3 |
| Dowanol ™ Eph | 0.001 | 17.8 | 5.7 | 14.3 |
| Dowanol PPH | 0.002 | 17.4 | 5.3 | 11.5 |
| Dowanol PMA | 0.330 | 15.6 | 5.6 | 9.8 |
| Ethyl Acetate | 4.106 | 15.8 | 5.8 | 7.2 |

*Hansen Solubility Parameter

In such embodiment, the ink jet printing may be used as a method for marking the laser-incident side of the media with the dye system materials. Using this process, one may which the polycarbonate index of refraction to minimize the interference from non-index matched materials. The transition from the substrate to the printing matrix has previously induced radial error termed “symmetry error.” Different patterns may be formed in the printing process.

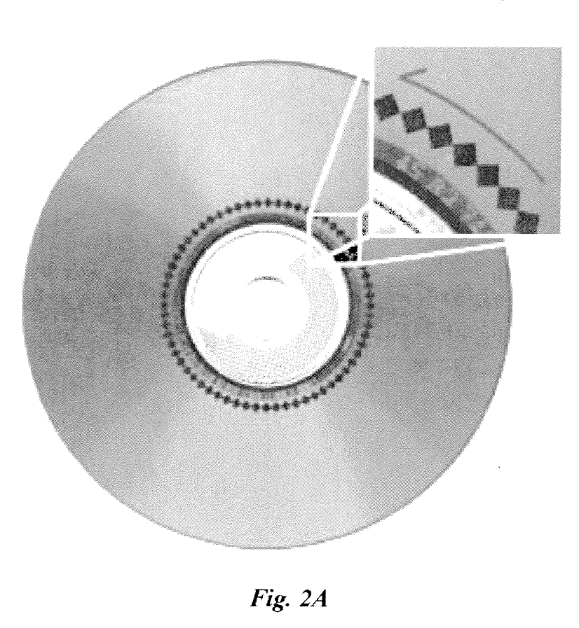

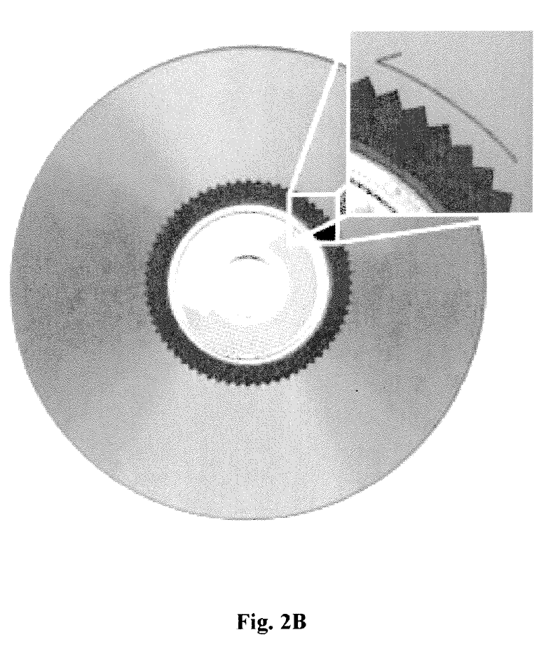

One possible printing pattern is shown in FIG. 2a. Such imprint is shown in a diamond-like pattern. Another possible pattern is the serrated edge print as shown in FIG. 2b. Such shapes may be found to reduce the symmetry error. Of course, other print patterns may be used, as would be understood by one of ordinary skill in the art.

In one ink jet printing embodiment, an image is ink jet printed on the laser incident side of the disc with a dye system designed to lock the disc from being played unless the dye system is activated appropriately (e.g., by exposure of the disc to a particular wavelength of light). Activation may be, for example, with a pulsed light source (at a frequency and wavelength, for example, as previously described in our prior applications). This may, for example, cause the writing or a label, being used to cause the anti-theft application to disappear.

Ink jet printing is well established for printing method for many types of plastic and paper labels used on optical discs. However, it is not believed that these methods have been employed for optical disc read-side printing. On the other hand, placing print on the read-side of the optical disc has been proposed and developed. These methods, which relate to a form of advertising have not been adopted widely by manufacturers of optical medium, such as Sony DADC. Read-side printing may suffer from a multitude of problems making the cost and risk associated with advertising or text writing an unacceptable risk. First, laser incident or read-side writing may not pass the read side symmetry testing.

It has been determined that these objections may be overcome in multiple ways: First, the read-side printing may be justified by placing functional optically changeable materials on the incident side. Second by using anti-theft compositions, such as disclosed in WO 2006/116493 A2, or as set forth below, after activation, the printed material is invisible to laser reader and therefore does not cause significant read-type errors. A further advantage to ink jet printing is the non-contact of the printing system to the optical disc material. This reduces the potential of scratching or marring the read surface during printing.

Functional printing, of a dye, may be used, allowing text to be written that can warn the consumer that the disc must be taken to the check out counter before and activated before it will play. In this case the optical absorption of the text itself may be used to increase the error-rate above the limit that a player can read through. After activation the dye may be selected so as to, for example, photobleach to an extent such that the error rate falls into compliance with requirements. Such functional printing may reduce the cost of advertising and reduce the temptation of un-authorized removal of the disc from the store. In this case the words on the laser incident side of the disc are lock that keeps the disc from being played.

Two types of ink jet printing may in particular be used which may have advantage as a methods to deliver the optically changeable dye system. A brief description of both is detailed below.

Ink-jet is a non-impact dot-matrix printing technology in which droplets of ink are jetted from a small aperture directly to a specified position on a media to create an image. The mechanism by which a liquid stream breaks up into droplets was described by Lord Rayleigh in 1878. In 1951, Elmqvist of Seimens patented the first practical Rayleigh break-up ink-jet device. This invention led to the introduction of the Mingograph, one of the first commercial ink-jet chart recorders for analog voltage signals. In the early 1960s, Dr. Sweet of Stanford University demonstrated that by applying a pressure wave pattern to an orifice, the ink stream could be broken into droplets of uniform size and spacing. When the drop break-off mechanism was controlled, an electric charge could be impressed on the drops selectively and reliably as they formed out of the continuous ink stream. The charged drops when passing through the electric field were deflected into a gutter for recirculation, and those uncharged drops could fly directly onto the media to form an image. This printing process is known as a continuous ink-jet or CIJ. By the late 1960s, Sweet's inventions led to the introductions of A. B. Dick VideoJet and the Mead DIJIT products. In the 1970s, IBM licensed the technology and launched a massive development program to adapt continuous ink-jet technology for their computer printers. The IBM 4640 ink-jet printer was introduced in 1976 as a word processing hardcopy-output peripheral application.

At approximately the same time, Professor Hertz of the Lund Institute of Technology in Sweden and his associates independently developed several continuous ink-jet techniques that had the ability to modulate the ink-flow characteristics for gray-scale ink-jet printing. One of Professor Hertz's methods of obtaining gray-scale printing was to control the number of drops deposited in each pixel. By varying the number of drops laid down, the amount of ink volume in each pixel was controlled, therefore the density in each color was adjusted to create the gray tone desired. This method was licensed to companies such as Iris Graphics and Stork to produce commercial high-quality color images for the computer prepress color hardcopy market.

While continuous ink-jet development was intense, the development of a drop-on-demand ink-jet or DOD method was also popularized. A drop-on-demand device ejects ink droplets only when they are used in imaging on the media. This approach eliminates the complexity of drop charging and deflection hardware as well as the inherent unreliability of the ink recirculation systems required for the continuous ink-jet technology.

Another type of ink jet printing entails the use of peizo technology. Piezo technology printing is currently used to print onto a variety of substrates including plastic cards, glossy and porous stocks. High resolution piezo drop-on-demand printing is seen in printers such as the Domino's A-Series printer. Such printer applies piezo shared-wall technology to print on a wide range of substrates using UV-cure ink. Oil and solvent inks available on request. The print head of the A-Series or MacroJet 2 contains a series of chambers that are filled with ink. By applying voltages to the walls of these chambers, a distortion is caused that bows the walls outwards. This distortion causes the ink pressure to drop, drawing more ink into the chamber. When the voltage is released and the walls return to their original positions, an ink droplet is expelled through each selected print nozzle. Collectively these droplets may be used to create high-resolution text, barcodes, graphics and variable data on to a variety of materials including plastic cards, glossy and porous stock.

In one embodiment, dye is applied by CIJ and/or DOD, while spinning the disc, which allows for the thickness of the dye coating to be metered and controlled to an accuracy of +/−10%. The printable dye system may be chosen, so that, in an initial state, prior to activation, the dye system may reduce the reflectivity of laser light below the minimum required for proper operation. For example, laser reflectivities of less than 0.1700 coating the lead-in area may stop the discs from playing. After activation, the transparency of dye system may increase above the reflective minimum of about 0.2220 which would allow the laser beam to be adequately reflected by the disc's metal layer and detected by the optical pick up unit of the reader thereby allowing the disc to play.

The dye application, using CIJ or DOD ink jet printing, may be performed simultaneously with printing the label side of the disc. The simultaneous printing of both sides of the disc, with resulting reduction of manufacturing time, provides a significant reduction in production cost.

In an alternative embodiment, the employed dye may be a transient state-change material wherein the initial state of the dye may prevent reading of the disc. A rapid change of state of the dye, resulting from activation by the check-out activator and every customer's set top player, may change optical properties so as to permit reading data from the medium. Software executed by the customer's set top player may utilize the change in state to allow reading the disc.

In a further advantageous embodiment, a mechanism may be employed that is not dependent on the dynamic response of the dye system. In such embodiment: indicia may be employed that on application could increase jitter above the playability average (JtAve ave 5.1416). This JtAve greater than (10.00) would not be playable in most optical discs players. After photo bleach or activation of the dye system, in such embodiment, the jitter would fall below the required average of 8.000 and the disc would play. This would be made possible by printing with an appropriate design, such as those set in FIGS. 2A and 2B, as discussed above. Such imprinting may be advantageous with any additional indicia or mark including but not limited to actual text printed around the lead in area of the disc.

### STATEMENT REGARDING PREFERRED EMBODIMENTS

While the invention has been described with respect to the foregoing, those skilled in the art will readily appreciate that various changes and/or modifications can be made to the invention without departing from the spirit or scope of the invention as defined by the appended claims.

What is claimed is:

1. A theft-protected digital recording medium comprising a disc having an optical state change material applied only in the lead-in area of the optical disc.

2. The theft-protected digital recording medium of claim 1 wherein the disc is an optical medium.

3. The theft-protected digital recording medium of claim 1 wherein the disc is not readable by a digital reader until the optical state change material is activated to new state.

4. The theft-protected digital recording medium of claim 1 wherein the disc is not readable by an optical reader until the optical state change material is activated to new state.

5. The theft-protected digital recording medium of claim 1 wherein the optical state change material is a light-activated state-change material.

6. The theft-protected digital recording medium of claim 1 wherein the optical state change material is selected from the group consisting of: a permanent state-change material, a temporary state-change material, and a transient state-change material.

7. The theft-protected digital recording medium of claim 1 wherein the disc is a transportable recording medium.

8. The theft-protected digital recording medium of claim 1 wherein the optical state change material is located over digital datum indicia in the lead-in area of the optical disc.

9. The theft-protected digital recording medium of claim 1 wherein the said digital recording medium comprises a polycarbonate disc at least partly covered by a thin protective coating operationally configured to protect said polycarbonate disc from chemical attack by solvents.

10. The theft-protected digital recording medium of claim 9 further comprising a pattern of said optical state change material placed on said thin protective coating.

11. A method for forming a theft-protected optical disc comprising imprinting, using an ink jet printer, an optical state change material only in the lead-in area of the optical disc.

12. The method of claim 11 wherein the said ink jet printer is a piezo printer.

13. The method of claim 11 wherein the imprinting is in visible text.

14. The method of claim 13 wherein the visible text indicates to a customer that the disc must be activated to be playable.

15. The method of claim 11 wherein the imprinting is in a diamond-like pattern.

14. The method of claim 11 wherein the imprinting is in a serrated-edge pattern.

15. The method of claim 11 wherein the said ink jet printer is a drop-on-demand (DOD) ink jet printer.

16. The method of claim 11 wherein the said ink jet printer is a continuous-ink-jet (CIJ) ink jet printer.

17. The method for forming a theft-protected optical disc, in accordance with claim 11, wherein the said optical state change material is imprinted substantially simultaneously with printing label on the opposite side of said theft-protected optical disc.
